(19) United States
(12) Patent Application Publication
(10) Pub. No.: US 2026/0264897 A1
(43) Pub. Date: Sep. 10, 2026

(54) ARM FIXATION MODULE AND UNMANNED AERIAL VEHICLE

(71) Applicant: Wistron Corporation, New Taipei City (TW)

(72) Inventors: Jian Rong LIAO, New Taipei City (TW); Yi Hsiang CHAO, New Taipei City (TW); Jen Chieh CHENG, New Taipei City (TW)

(21) Appl. No.: 19/013,233

(22) Filed: Jan. 8, 2025

(30) Foreign Application Priority Data
Oct. 30, 2024 (TW) 113141709

(51) Int. Cl. B64U 30/293; B64U 10/14; B64U 30/21

(52) U.S. Cl. CPC B64U 30/293; B64U 10/14; B64U 30/21

(57) ABSTRACT

An arm fixation module and an unmanned aerial vehicle (UAV) are provided. The arm fixation module includes a housing, an arm, and a locking assembly. The arm extends along a first direction. A first end portion of the arm is pivotally connected to the housing. A first connecting portion is set on the first end portion. The locking assembly is set in the housing and includes a fastening member that is configured to move along a second direction. A second connecting portion is set on a surface of the fastening member facing the arm. The second connecting portion is configured to detachably connect to the first connecting portion. The first direction is different from the second direction.

### CROSS-REFERENCE TO RELATED APPLICATION

This non-provisional application claims priority under 35 U.S.C. § 119(a) to Patent Application No. 113141709 filed in Taiwan, R.O.C. on Oct. 30, 2024, the entire contents of which are hereby incorporated by reference.

### BACKGROUND

### Technical Field

The present disclosure relates to an unmanned aerial vehicle (UAV) and a structure thereof, and in particular, to a UAV with a fixable arm and an arm fixation module.

### Related Art

Stability of an unmanned aerial vehicle (UAV) during flight is crucial to system control of the UAV, and one of main factors affecting the stability is a structural design of a wing.

Currently, wings of the UAV in the market are mainly divided into two types: a foldable wing and a fixed wing. Since the fixed wing is integrated with a body structure of the UAV, the overall strength is relatively high, and higher stability can be provided. However, a disadvantage of the fixed wing is mainly reflected in a large volume thereof, which makes the UAV with such a wing inconvenient to carry and store, causing great trouble in situations where long-distance transportation or operations at multiple locations are required.

To improve portability, a foldable UAV has gradually become a mainstream choice in the market. In this type of UAV, a hinge is usually used as a folding mechanism inside the wing. A structural design and processing quality of the hinge are directly related to stability of the wing after being expanded. In the structural design of the hinge, a problem of mechanism interference between the wing and a housing may occur, causing the UAV to sway. Alternatively, due to an unavoidable tolerance during manufacturing and assembly, tiny gaps may exist in the hinge structure after being expanded. The tiny gaps may cause the wing to sway during the flight. In addition, if the hinge structure has insufficient strength, the hinge structure is unable to resist strong wind interference in a flight environment, which also causes the wing to sway violently. In the foregoing situations, a less serious situation may be that unstable direction control of the UAV may be caused, and a serious situation may be that even a crash of the UAV may be triggered.

Therefore, how to enhance the stability of fixation of the wing of the UAV, reduce a structure gap, and improve structural strength to seek a balance between stability and portability is an important issue that needs to be considered in design of the UAV.

### SUMMARY

In view of this, the applicant proposes an unmanned aerial vehicle (UAV) arm fixation module. The arm fixation module includes a housing, an arm, and a locking assembly. The arm extends along a first direction. The arm has a first end portion and a second end portion. The first end portion is pivotally connected to the housing. A first connecting portion is set on the first end portion. The locking assembly is set in the housing. The locking assembly includes a fastening member. The fastening member is configured to move along a second direction. A second connecting portion is set on a surface of the fastening member facing the arm. The second connecting portion is configured to detachably connect to the first connecting portion. The first direction is different from the second direction.

The applicant further proposes a UAV. The UAV includes a plurality of arm fixation modules and a plurality of rotary wings. Each of the arm fixation modules includes a housing, an arm, and a locking assembly. The arm extends along a first direction. The arm has a first end portion and a second end portion. The first end portion is pivotally connected to the housing. A first connecting portion is set on the first end portion. The locking assembly is set in the housing. The locking assembly includes a fastening member. The fastening member is configured to move along a second direction. A second connecting portion is set on a surface of the fastening member facing the arm. The second connecting portion is configured to detachably connect to the first connecting portion. The first direction is different from the second direction. The plurality of rotary wings are each pivotally connected to the second end portion of the arm of each of the arm fixation modules.

### BRIEF DESCRIPTION OF THE DRAWINGS

FIG. 1 is a three-dimensional view of an unmanned aerial vehicle (UAV) in an unexpanded state according to some embodiments;

FIG. 2 is a three-dimensional view of a UAV in an expanded state according to some embodiments;

FIG. 3 is a disassembly diagram of an arm fixation module according to some embodiments;

FIG. 4 is a dynamic schematic diagram of an arm during deployment according to some embodiments;

FIG. 5 is a three-dimensional view of an arm fixation module in a fixed state according to some embodiments;

FIG. 6A to FIG. 6H are cross-sectional views of an active state of an arm fixation module according to some embodiments;

FIG. 7 is a schematic diagram of a strip-shaped sliding groove according to some embodiments;

FIG. 8 is a cross-sectional view of an arm fixation module according to some other embodiments; and

FIG. 9 is a cross-sectional view of arm fixation modules in pairs according to some embodiments.

### DETAILED DESCRIPTION

A term “a/an” or “one” herein is used to describe an element and a component of the present invention. This term is only used for the convenience of description and to provide a basic concept of the present invention. The description is to be further understood to include one or at least one, and unless explicitly indicated otherwise, include the plural when indicating the singular. When used together with the word “include” or “comprise” within the scope of the patent application, the term “one” may mean one or more than one.

Unless otherwise specified, spatial descriptions such as “up”, “down”, “left”, “right”, “front”, “back”, “inside”, “outside”, “close to”, “away from”, “body”, “vertical”, and “parallel” are indicative of directions shown in the drawing. It should be understood that the spatial descriptions used herein are for illustrative purposes only. An actual implementation of the structure described herein may be configured in space in any relative direction. This constraint does not change advantages of embodiments of the present disclosure.

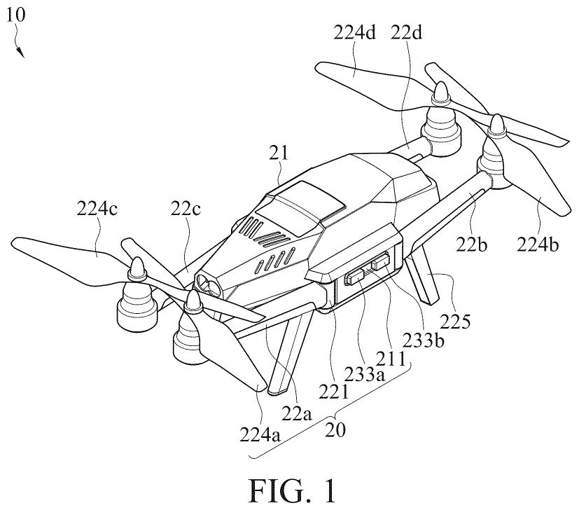

FIG. 1 is a three-dimensional view of an unmanned aerial vehicle (UAV) in an unexpanded state according to some embodiments. Refer to FIG. 1. A UAV 10 in this embodiment includes four sets of arm fixation modules 20. One of the arm fixation modules 20 includes a housing 21, an arm 22a, and a locking assembly 23a (shown in FIG. 5). The arm 22a is pivotally connected to the housing 21. The locking assembly 23a is set inside the housing 21, and configured to lock the arm 22a. In this embodiment, the housing 21 of the UAV 10 includes upper and lower covers. The housing 21 of a body (for example, a control circuit or a sensor layout position) is formed together with the housing 21 of the arm fixation module 20. In another embodiment, the arm fixation module 20 may have an independent housing 21, which is configured to be mounted to a shell of the body of the UAV 10. The arm 22a includes a first end portion 222 and a second end portion 223. The first end portion 222 is connected to the housing 21 through a pivot 221. A direction of the pivot 221 is parallel to an up-down direction of the UAV 10, so that the arm 22a may be expanded toward a left side or a right side. In this embodiment, to reduce mechanism interference between the arm 22a and the housing 21, the arm 22a is fixed to the housing 21 only through pivotal connection. The locking assembly 23a includes a movable component. When the arm 22a is in a locked state, the locking assembly 23a engages and fixes the arm 22a. When the arm 22a is in an unlocked state, the locking assembly 23a is not connected to the arm 22a. It should be understood that the first end portion 222 may refer to a portion (close to a side of the housing 21) before a middle point of a long axis of the arm 22a. The second end portion 223 may refer to a portion (away from a side of the housing 21) beyond the middle point of the long axis of the arm 22a, and is not limited to an end point of the arm 22a.

For ease of description, the following embodiments are described by using the UAV 10 including four sets of arm fixation modules 20 as an example. However, in another embodiment, the UAV 10 includes at least more than two sets of arm fixation modules 20, to maintain flight stability.

As shown in FIG. 1, four arms 22a, 22b, 22c, and 22d of the UAV 10 are in an unexpanded state. In this embodiment, the housing 21 of the UAV 10 has a long strip-shaped three-dimensional structure having a long axis direction. The four folded arms 22a, 22b, 22c, and 22d extend along the long axis direction to minimize a volume. Two sets of arm fixation modules 20 are set on a left side of the UAV 10, and the other two sets of arm fixation modules 20 are set on a right side of the UAV 10 (not shown in the figure). The arm fixation module 20 on the left side is provided with a strip-shaped sliding groove 211 on the housing 21. The strip-shaped sliding groove 211 provides a space for a push lock 233a and a push lock 233b to slide. In this embodiment, a sliding direction of the push lock 233a (and an internal locking assembly) is parallel to the long axis direction of the UAV 10. Specifically, for the arm fixation module 20 on a left front side of the UAV 10, a user presses the push lock 233a and slides backward to unlock the arm 22a on the left front side. For the arm fixation module 20 on a left rear side of the UAV 10, the user presses the push lock 233b and slides forward to unlock the arm 22b on the left rear side. In this embodiment, the strip-shaped sliding grooves 211 of the arm fixation modules 20 on the left front side and the left rear side are in communication with each other, to allow the two push locks 233a and 233b to slide simultaneously within ranges of the strip-shaped sliding grooves. However, the strip-shaped sliding grooves 211 for accommodating the push locks 233a and 233b may also be configured separately. In this embodiment, after the arms 22a, 22b, 22c, and 22d are unlocked through the push locks, the arms can move freely to be expanded toward the left side or the right side. In another embodiment, when the four arms 22a, 22b, 22c, and 22d of the UAV 10 are in the unexpanded state, the push lock does not have a locking function. Therefore, the locking assembly in the unexpanded state is not connected to the arms 22a, 22b, 22c, and 22d. The arms 22a, 22b, 22c, and 22d may still move freely.

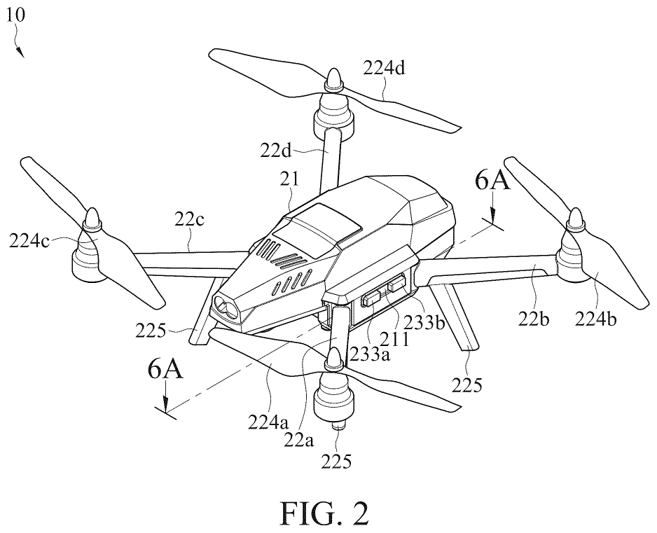

FIG. 2 is a three-dimensional view of a UAV in an expanded state according to some embodiments. Refer to FIG. 2. When four arms 22a, 22b, 22c, and 22d of a UAV 10 are in an expanded state, a push lock has a locking function. A user may lock or unlock the arms 22a, 22b, 22c, and 22d by pressing and sliding the push lock. The UAV 10 with the arms 22a, 22b, 22c, and 22d being expanded is bilaterally symmetrical, so that a center of gravity falls on a body portion of the UAV 10. Each of rotary wings 224a, 224b, 224c, and 224d may be set on a second end portion 223 of each of the arms 22a, 22b, 22c, and 22d. Each of the rotary wings 224a, 224b, 224c, and 224d is driven by a motor (not shown in the figure) set on the second end portion 223 of each of the arms 22a, 22b, 22c, and 22d. The motor is electrically connected to a control circuit of the body portion of the UAV 10 through a circuit inside a shell of each of the arms 22a, 22b, 22c, and 22d. In this embodiment, each of the arms 22a, 22b, 22c, and 22d is provided with a supporting rod 225. The supporting rod 225 extends from a first end portion 222 (that is, close to the body portion) of each of the arms 22a, 22b, 22c, and 22d toward the bottom of each of the arms 22a, 22b, 22c, and 22d. In some embodiments, the supporting rod 225 is inclined toward the long axis direction of each of the arms 22a, 22b, 22c, and 22d toward the second end portion 223 of each of the arms 22a, 22b, 22c, and 22d. In this way, when the arms 22a, 22b, 22c, and 22d are in the expanded state, the supporting rod 225 is also simultaneously expanded, thereby improving stability of the UAV 10 during landing.

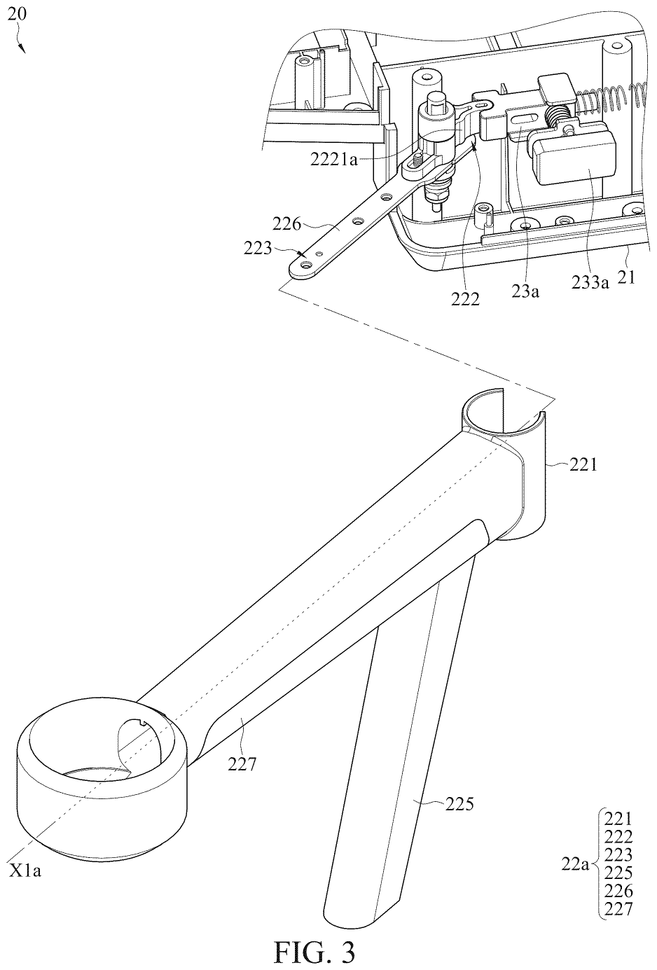

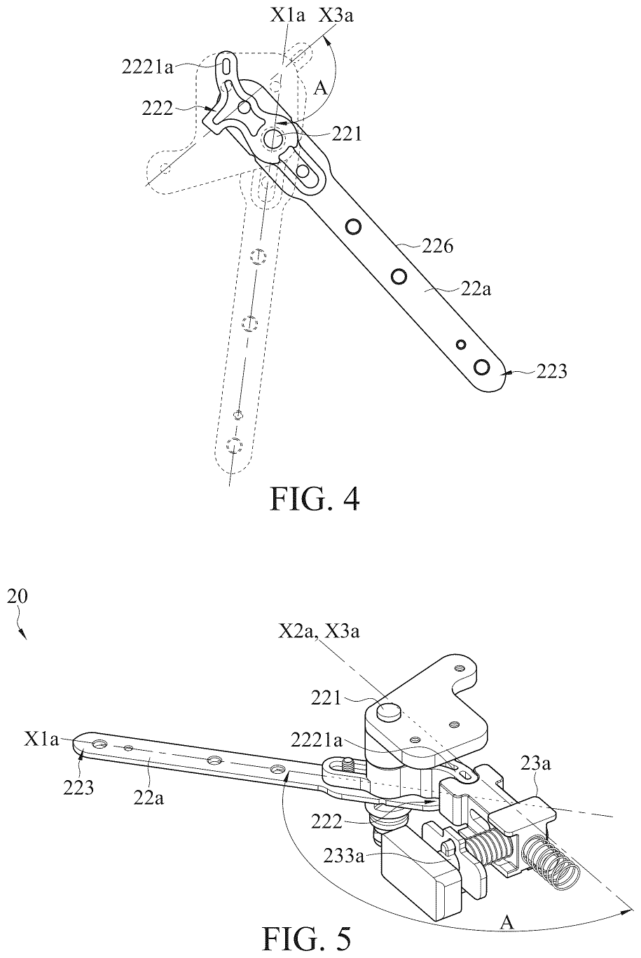

FIG. 3 is a disassembly diagram of an arm fixation module according to some embodiments. FIG. 4 is a dynamic schematic diagram of an arm during deployment according to some embodiments. FIG. 5 is a three-dimensional view of an arm fixation module in a fixed state according to some embodiments. Refer to FIG. 3 to FIG. 5 together. The following embodiments are described by using an arm fixation module 20 as an example. However, the means listed in the embodiments may be applied by analogy to another arm fixation module 20 of the same UAV 10. In this embodiment, an arm 22a includes a rod unit 226 and an arm shell 227. The arm 22a extends along a first direction X1a. A first end portion 222 of the arm shell 227 may be connected to a housing 21 by using a pivot 221. The first end portion 222 of the rod unit 226 of the arm 22a is provided with a first connecting portion 2221a protruding outward from the first end portion 222 of the arm 22a along a third direction X3a. The housing 21 includes a locking assembly 23a inside. The locking assembly 23a may be configured to connect to the first connecting portion 2221a of the arm 22a. A push lock 233a and the locking assembly 23a are connected to each other. The push lock 233a may be configured to drive the locking assembly 23a to move back and forth along a second direction X2a, to engage or disengage the first connecting portion 2221a of the arm 22a by using the locking assembly 23a, thereby implementing locking or unlocking. For the sake of description, only a part of the rod unit 226 of the arm 22a of the subsequent embodiments is presented.

As shown in FIG. 4, a long axis of the rod unit 226 of the arm 22a is the first direction X1a. An extending direction in which the first connecting portion 2221a protrudes outward is the third direction X3a. An included angle A is defined between the first direction X1a and the third direction X3a. When the rod unit 226 of the arm 22a rotates with the pivot 221 as a center, the first connecting portion 2221a also rotates accordingly. In this embodiment, when the arm 22a is in an unexpanded state, the first connecting portion 2221a points to a left side of the UAV 10 along the third direction X3a (the first connecting portion of each of the arms 22c and 22d on a right side points to the right side). When the arm 22a is adjusted from the unexpanded state to an expanded state, the first connecting portion 2221a rotates counterclockwise with the pivot 221 as the center. When the arm 22a is fully expanded, the first connecting portion 2221a points to a rear side of the UAV 10 along the third direction X3a (the first connecting portion of each of the arms 22b and 22d on the rear side points to a front side). As shown in FIG. 5, in this case, the third direction X3a is parallel to the second direction X2a. In this way, when the locking assembly 23a moves forward, the locking assembly 23a may engage the first connecting portion 2221a of the arm 22a, to achieve a fixation effect of the arm 22a. In some embodiments, the included angle A between the first direction X1a and the third direction X3a is greater than or equal to 90 degrees and less than 180 degrees. When the included angle A between the first direction X1a and the third direction X3a is greater than 180 degrees, the arm 22a can only be fixed in the unexpanded state and is prone to damage caused by mechanism interference among rotary wings 224a, 224b, 224c, and 224d. When the included angle A between the first direction X1a and the third direction X3a is less than 90 degrees, the arm 22a may be fixed in the expanded state. However, a deployment angle of the arm 22a causes the center of gravity in the front-to-rear direction of the UAV 10 to deviate, which may affect flight stability, and the mechanism interference among the rotary wings 224a, 224b, 224c, and 224d may also occur, resulting in damage.

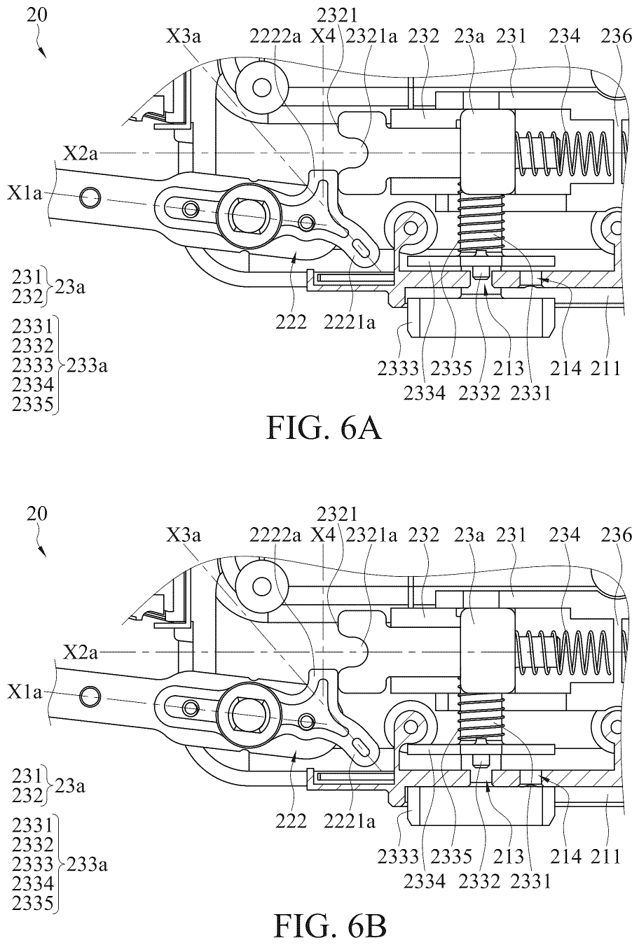

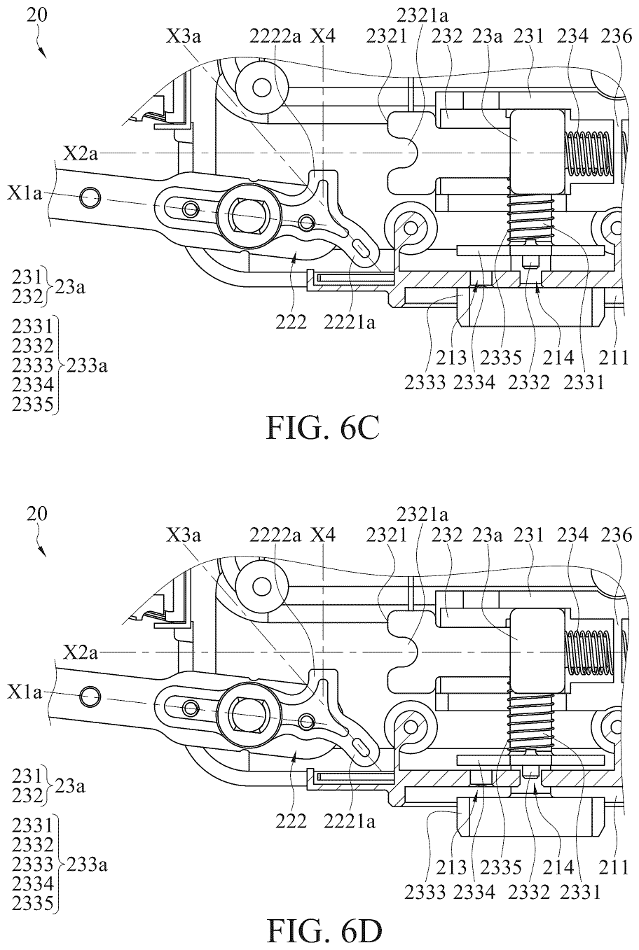

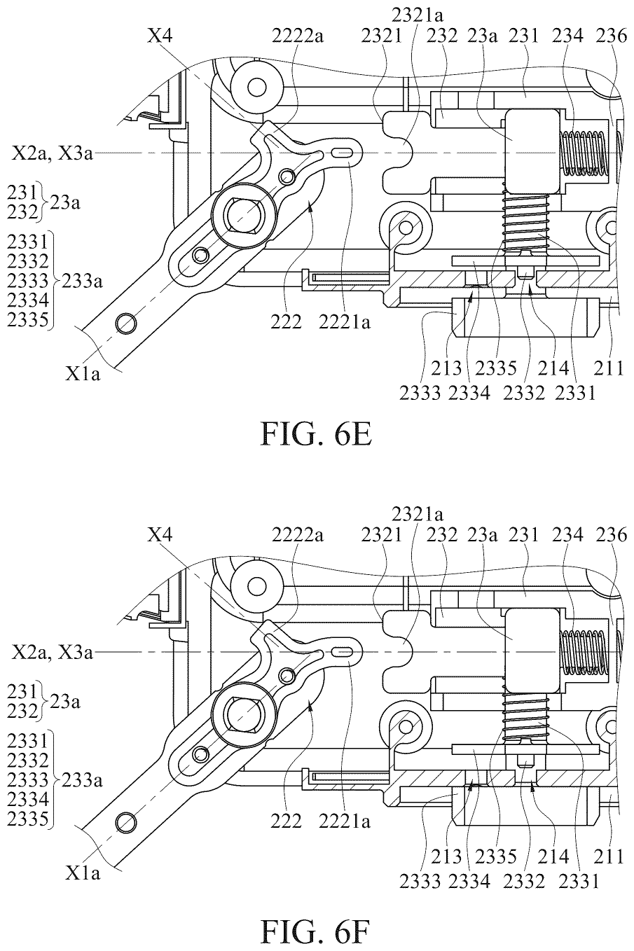

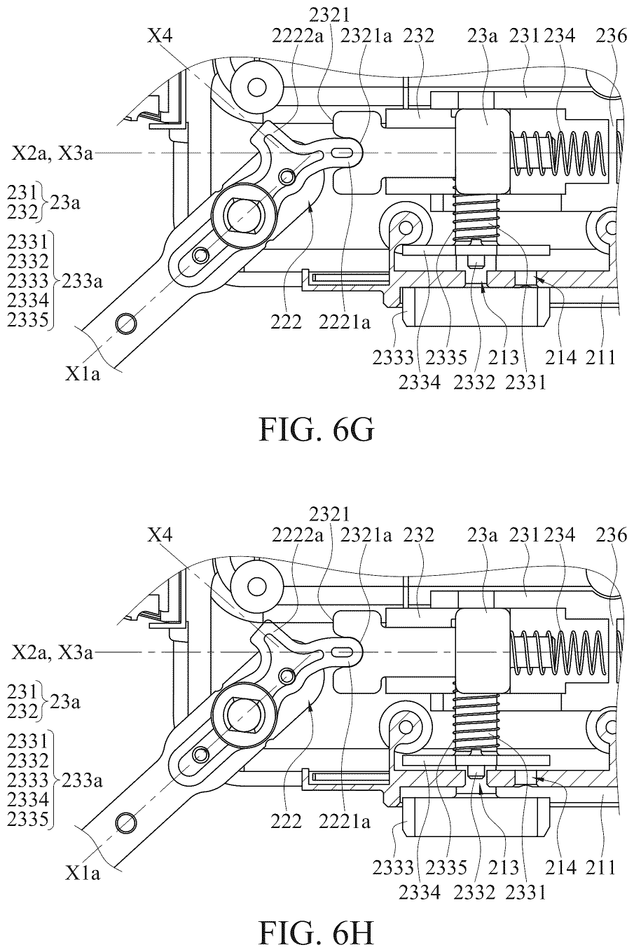

FIG. 6A to FIG. 6H are cross-sectional views of an active state of an arm fixation module according to some embodiments. Refer to FIG. 6A to FIG. 6H in sequence. To describe an operation mode of the arm fixation module 20 in detail, a description is provided in sequence below based on adjustment of the arm 22a from an unexpanded state to an expanded state.

As shown in FIG. 6A, the arm fixation module 20 of this embodiment is in the unexpanded state. The arm 22a is folded in front of a UAV 10 and locked and fixed. In this embodiment, a first end portion 222 of the arm 22a is provided with a first connecting portion 2221a and a third connecting portion 2222a. The first connecting portion 2221a protrudes outward along a third direction X3a and points to a left side of the UAV 10. The third connecting portion 2222a protrudes outward along a fourth direction X4 and points to a body of the UAV 10. The locking assembly 23a includes a guide rail 231 and a fastening member 232. The guide rail 231 extends toward the first end portion 222 of the arm 22a along a second direction X2a. The fastening member 232 slides in the guide rail 231 along the second direction X2a to move close to the first end portion 222 or move away from the first end portion 222. In addition, a surface 2321 of the fastening member 232 facing the arm 22a is provided with a second connecting portion 2321a. The second connecting portion 2321a is recessed inward from the surface 2321 of the fastening member 232. In this embodiment, the third connecting portion 2222a protrudes outward and includes a side surface. When the arm 22a is in the unexpanded state, the side surface is parallel to the surface 2321 of the fastening member 232. When the fastening member 232 slides forward in the guide rail 231 to move close to the first end portion 222, the surface 2321 of the fastening member 232 abuts against the side surface of the third connecting portion 2222a, so that the arm 22a is fixed. In some embodiments, an included angle between the first direction X1a and the fourth direction X4 of the arm 22a is less than 180 degrees. The third connecting portion 2222a of this embodiment causes the arm 22a to be fixed in the unexpanded state, to avoid mechanism interference between the first connecting portion 2221a and the fastening member 232 and even a fracture of the first connecting portion 2221a caused by swaying of the arm 22a. In another embodiment, the first end portion 222 of the arm 22a is provided with only the first connecting portion 2221a and not provided with the third connecting portion 2222a. Therefore, the arm 22a in the unexpanded state may still move freely.

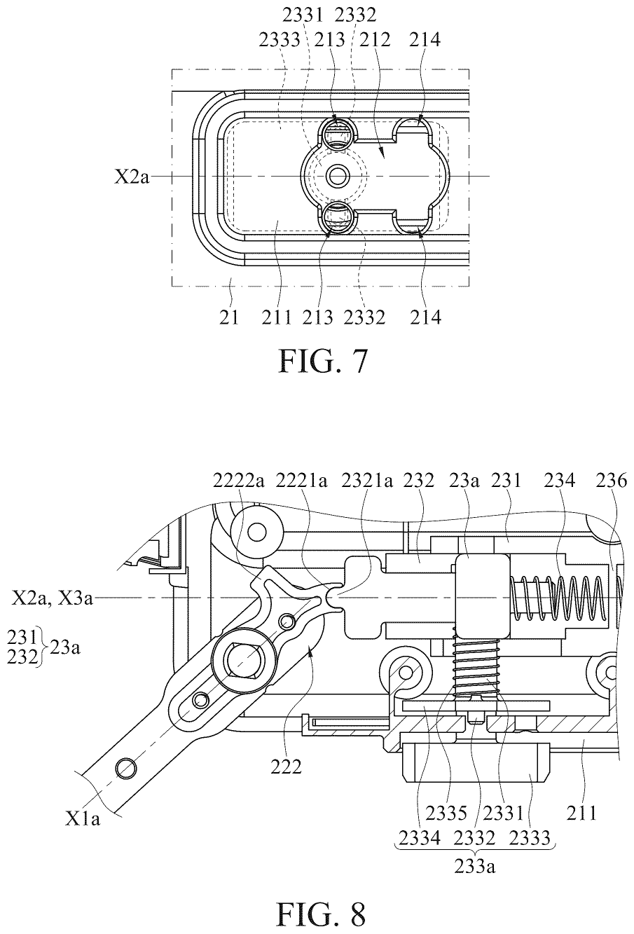

In some embodiments, the locking assembly 23a mates with the arm 22a to fix the arm 22a. In this embodiment, a housing 21 of the arm fixation module 20 further includes a strip-shaped through hole 212. The locking assembly 23a further includes a push lock 233a. The push lock 233a includes a connecting rod 2331, a protrusion 2332, and a button 2333. FIG. 7 is a schematic diagram of a strip-shaped sliding groove according to some embodiments. Refer to FIG. 6A and FIG. 7 together. In this embodiment, a long axis of a strip-shaped through hole 212 extends along a second direction X2a. A short axis of the strip-shaped through hole 212 matches an outer diameter of the connecting rod 2331 to allow a connecting rod 2331 to slide back and forth in the strip-shaped through hole 212. The strip-shaped through hole 212 in FIG. 7 is set in the arm fixation module 20 in left front of a UAV 10. A front end of the strip-shaped through hole 212 includes a first lock hole portion 213, and a rear end includes a second lock hole portion 214. As shown in FIG. 7, the front end of the strip-shaped through hole 212 includes two first lock hole portions 213, which are respectively located above and below the front end of the strip-shaped through hole 212. The rear end of the strip-shaped through hole 212 includes two second lock hole portions 214, which are respectively located above and below the rear end of the strip-shaped through hole 212. Inner diameters of the first lock hole portion 213 and the second lock hole portion 214 match an outer diameter of the protrusion 2332, to allow the protrusions 2332 to be accommodated respectively. As shown in FIG. 6A, the connecting rod 2331 is vertically and axially movably connected to the fastening member 232. The connecting rod 2331 extends beyond the housing 21 through the strip-shaped through hole 212, and is connected to the button 2333 outside the housing 21. The protrusion 2332 is connected to a side surface of the connecting rod 2331, to engage the first lock hole portion 213 or the second lock hole portion 214. The button 2333 may be configured to drive the connecting rod 2331 to move along the second direction X2a. In this embodiment, an upper end and a lower end of the side surface of the connecting rod 2331 are each provided with a protrusion 2332. The push lock 233a is located at the front end of the strip-shaped through hole 212, and the two protrusions 2332 of the connecting rod 2331 are engaged with the first lock hole portion 213.

To improve tightness between the push lock 233a and the first lock hole portion 213, the push lock 233a of this embodiment includes a connecting rod 2331, a first spring 2335, an plate 2334, a protrusion 2332, and a button 2333. The plate 2334 is sleeved on the connecting rod 2331. The connecting rod 2331 extends through the first spring 2335, and the first spring 2335 is set between an inner side of the plate 2334 and the fastening member 232. The protrusion 2332 is connected to the side surface of the connecting rod 2331 on an outer side of the plate 2334. The first spring 2335 pushes the plate 2334 and the connecting rod 2331 outward, so that the protrusion 2332 is stably engaged in the first lock hole portion 213. Therefore, the protrusion 2332 is not disengaged from the first lock hole portion 213 so that the locking assembly 23a slides to result in swaying of the arm 22a, even when vibration occurs during flight of the UAV 10. In another embodiment, the push lock 233a includes only a connecting rod 2331, a protrusion 2332, and a button 2333. To fix the locking assembly 23a, the protrusion 2332 may also include a hook, to be fixed to the first lock hole portion 213 or the second lock hole portion 214 by using the hook, and to disengage the hook by pressing the button 2333. The locking assembly 23a of this embodiment includes the guide rail 231, the fastening member 232, and a second spring 234. An end plate 236 is connected to a side, which is away from the first end portion 222 of the arm 22a, of the guide rail 231. The second spring 234 is set between the end plate 236 and the fastening member 232. The second spring 234 pushes the fastening member 232 forward, so that the fastening member 232 is stably engaged with the first connecting portion 2221a or the third connecting portion 2222a. Therefore, the locking assembly 23a does not slide to result in swaying of the arm 22a, even when the protrusion 2332 is disengaged from the first lock hole portion 213. In another embodiment, the locking assembly 23a includes only the guide rail 231 and the fastening member 232. To fix the locking assembly 23a, the locking assembly 23a may also be prevented from sliding through a close fit between the protrusion 2332 and the first lock hole portion 213 or the second lock hole portion 214.

As shown in FIG. 6B, the arm fixation module 20 of this embodiment is in the unexpanded state. The arm 22a is folded in front of a UAV 10 and locked and fixed. In this embodiment, the fastening member 232 includes a through hole which is in communication with left and right side surfaces of the fastening member 232. The connecting rod 2331 extends through the fastening member 232 and is axially movably connected to the fastening member 232. When a user presses the button 2333 to push the connecting rod 2331, the connecting rod 2331 moves inward along an axial direction to cause the protrusion 2332 to be disengaged from the first lock hole portion 213. In this case, the user may further push the button 2333 to the right, so that the connecting rod 2331 slides to the right along the strip-shaped sliding groove 211 (the rear of the UAV 10), and drives the fastening member 232 to move to the right, thereby presenting a state shown in FIG. 6C.

As shown in FIG. 6D, the arm fixation module 20 of this embodiment is in the unexpanded state. The arm 22a is folded in front of a UAV 10 and has been unlocked. In this embodiment, the connecting rod 2331 is located on a right side of the strip-shaped sliding groove 211, and the fastening member 232 is located on a right side of the guide rail 231 (the rear of the UAV 10). In this case, when the user releases fingers, the first spring 2335 pushes the connecting rod 2331 outward, to cause the protrusion 2332 to be engaged with the second lock hole portion 214. In another embodiment, the user pulls the button 2333 outward, to cause the protrusion 2332 of the connecting rod 2331 to be engaged with the second lock hole portion 214.

As shown in FIG. 6E, the arm fixation module 20 of this embodiment is in the expanded state. The arm 22a rotates toward the left of the UAV 10 and is unlocked. In this case, the arm 22a may rotate freely. In this embodiment, the third direction X3a of the first connecting portion 2221a of the first end portion 222 of the arm 22a is parallel to a movement direction (the second direction X2a) of the locking assembly 23a.

As shown in FIG. 6F, the arm fixation module 20 of this embodiment is in the expanded state. The arm 22a points to the left front of the UAV 10 and is unlocked. In this embodiment, when the user presses the button 2333 to push the connecting rod 2331, the connecting rod 2331 moves inward along an axial direction to cause the protrusion 2332 to be disengaged from the second lock hole portion 214. In this case, the user may further push the button 2333 to the left, so that the connecting rod 2331 slides to the left (the front of the UAV 10) along the strip-shaped sliding groove 211, and drives the fastening member 232 to move to the left, thereby presenting a state shown in FIG. 6G.

As shown in FIG. 6H, the arm fixation module 20 of this embodiment is in the expanded state. The arm 22a points to the left front of the UAV 10 and has been locked. In this embodiment, the connecting rod 2331 is located on a left side of the strip-shaped sliding groove 211, and the fastening member 232 is located on a left side of the guide rail 231 (in front of the UAV 10). In this case, when the user releases fingers, the first spring 2335 pushes the connecting rod 2331 outward, to cause the protrusion 2332 to be engaged with the first lock hole portion 213. In another embodiment, the user pulls the button 2333 outward, to cause the protrusion 2332 of the connecting rod 2331 to be engaged in the first lock hole portion 213. In this embodiment, the second connecting portion 2321a of the fastening member 232 is recessed inward from the surface 2321 of the fastening member 232, and a shape thereof corresponds to the first connecting portion 2221a. For example, an end of the first connecting portion 2221a presents an arcuate convex surface. The second connecting portion 2321a presents an arcuate concave surface. The arcuate concave surface of the second connecting portion 2321a catches and fixes the arcuate convex surface of the first connecting portion 2221a, thereby preventing the arm 22a from swaying. In some embodiments, a surface of the arc surface is a smooth surface, to improve tightness between the first connecting portion 2221a and the second connecting portion 2321a.

FIG. 8 is a cross-sectional view of an arm fixation module according to some other embodiments. Refer to FIG. 8. In this embodiment, an arm 22a extends along a first direction X1a. A first end portion 222 of the arm is connected to a housing 21 by using a pivot 221. The first end portion 222 of the arm 22a is provided with a first connecting portion 2221a, which is recessed inward from the first end portion 222 of the arm 22a along a third direction X3a. A fastening member 232 slides in a guide rail 231 along a second direction X2a to move close to the first end portion 222 or move away from the first end portion 222. In addition, a surface 2321 of the fastening member 232 facing the arm 22a is provided with a second connecting portion 2321a. The second connecting portion 2321a protrudes outward from the surface 2321 of the fastening member 232. In this embodiment, a shape of the second connecting portion 2321a corresponds to the first connecting portion 2221a. An end of the first connecting portion 2221a presents an arcuate concave surface. The second connecting portion 2321a presents an arcuate convex surface. The arcuate concave surface of the first connecting portion 2221a catches and fixes the arcuate convex surface of the second connecting portion 2321a, thereby preventing the arm 22a from swaying.

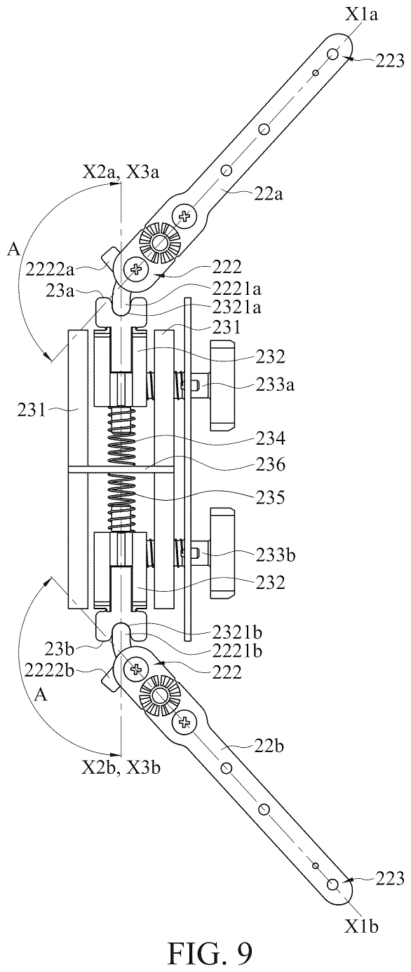

FIG. 9 is a cross-sectional view of arm fixation modules in pairs according to some embodiments. Refer to FIG. 1 and FIG. 9 together. This embodiment includes two sets of arm fixation modules 20. The arm fixation module 20 in an upper part of FIG. 9 corresponds to the arm fixation module 20 on the left front of the UAV 10 in FIG. 1. The arm fixation module 20 in a lower part of FIG. 9 corresponds to the arm fixation module 20 on the left rear of the UAV 10 in FIG. 1. In this embodiment, the arms 22a and 22b are both in a locked state. An included angle A is formed between a first direction X1a of the arm 22a and a third direction X3a of a first connecting portion 2221a. The third direction X3a is parallel to a second direction X2a of a guide rail 231 of a locking assembly 23a. The first connecting portion 2221a is fixed by a second connecting portion 2321a. An included angle A is formed between a fifth direction X1b of the arm 22b and a sixth direction X2b of a fourth connecting portion 2221b. A sixth direction X2b is parallel to a seventh direction X3b of the guide rail 231 of a locking assembly 23b. The fourth connecting portion 2221b is fixed by a second connecting portion 2321b. In this embodiment, a first end portion 222 of the arm 22a is provided with a third connecting portion 2222a. The first end portion 222 of the arm 22b is provided with a fifth connecting portion 2222b, so that the arms 22a and 22b may be respectively fixed by the locking assembly 23a or the locking assembly 23b in an unexpanded state.

The locking assembly 23a includes a guide rail 231, a fastening member 232, and a second spring 234. The locking assembly 23b includes a guide rail 231, a fastening member 232, and a third spring 235. Sides of two sets of guide rails 231 away from the first end portions 222 of the arms 22a and 22b are connected together to an end plate 236. The second spring 234 is set between the end plate 236 and the fastening member 232 of the locking assembly 23a. The third spring 235 is set between the end plate 236 and the fastening member 232 of the locking assembly 23b. In this way, the second spring 234 applies a force to an upper part of FIG. 9 (the front of the UAV 10), to engage the first connecting portion 2221a or the third connecting portion 2222a of the arm 22a. The third spring 235 applies a force to a lower part of FIG. 9 (the rear of the UAV 10) to engage the fourth connecting portion 2221b or the fifth connecting portion 2222b of the arm 22b.

In this embodiment, the locking assembly 23a includes a push lock 233a. The locking assembly 23b includes a push lock 233b. Connecting rods 2331 of the push lock 233a and the push lock 233b respectively extend through the housing 21. As shown in FIG. 1, the push lock 233a and the push lock 233b are located in a same strip-shaped sliding groove 211. One advantage is that the user may simultaneously press buttons 2333 of the push lock 233a and the push lock 233b with a thumb and an index finger of one hand, and then put the thumb and the index finger together to simultaneously unlock the arm 22a and the arm 22b. Similarly, the arm 22c and the arm 22d on the other side of the UAV 10 may also be simultaneously unlocked with the other hand in the same operation manner. In this way, in this embodiment, the user may complete the operation of locking or unlocking the UAV 10 with both hands, without needing to adjust the arm fixation module 20 one by one for the arms 22a, 22b, 22c, and 22d.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. An arm fixation module, comprising:
a housing;
an arm, extending along a first direction, wherein the arm has a first end portion and a second end portion, the first end portion is pivotally connected to the housing, and a first connecting portion is set on the first end portion; and
a locking assembly, set in the housing, wherein the locking assembly comprises a fastening member, the fastening member is configured to move along a second direction, a second connecting portion is set on a surface of the fastening member facing the arm, the second connecting portion is configured to detachably connect to the first connecting portion, and the first direction is different from the second direction.

2. The arm fixation module according to claim 1, wherein the housing further comprises a strip-shaped through hole, the strip-shaped through hole extends along the second direction and comprises a first lock hole portion and a second lock hole portion, the fastening member further comprises a push lock, and the push lock comprises:
a connecting rod, movably connected to the fastening member, wherein the connecting rod extends through the strip-shaped through hole of the housing;
a protrusion, connected to a side surface of the connecting rod, wherein the protrusion is configured to engage the first lock hole portion or the second lock hole portion; and
a button, set outside the housing and connected to an end of the connecting rod.

3. The arm fixation module according to claim 2, wherein the push lock further comprises a plate and a first spring, the plate is sleeved on the connecting rod, the connecting rod extends through the first spring, the first spring is set between an inner side of the plate and the fastening member, and the protrusion is connected to the side surface of the connecting rod on an outer side of the plate.

4. The arm fixation module according to claim 2, wherein the housing further comprises a strip-shaped sliding groove set on an outer surface of the housing, the strip-shaped through hole is set in the strip-shaped sliding groove, and the button slides in the strip-shaped sliding groove.

5. The arm fixation module according to claim 1, wherein the first connecting portion protrudes from the first end portion along a third direction, and the second connecting portion is recessed from the surface of the fastening member.

6. The arm fixation module according to claim 5, wherein a third connecting portion is set at the first end portion of the arm, the third connecting portion protrudes from the first end portion of the arm along a fourth direction, and when the third direction deviates from the second direction, the fastening member is configured to connect to the third connecting portion.

7. The arm fixation module according to claim 1, wherein the first connecting portion is recessed from the first end portion along a third direction, and the second connecting portion protrudes from the surface of the fastening member.

8. The arm fixation module according to claim 1, wherein the arm further comprises a supporting rod extending from the first end portion of the arm toward the bottom of the arm.

9. The arm fixation module according to claim 1, wherein the locking assembly further comprises a guide rail, the guide rail extends along the second direction toward the first end portion of the arm, and the fastening member is configured to slide along the guide rail.

10. The arm fixation module according to claim 9, wherein the locking assembly further comprises a second spring, a side of the guide rail away from the first end portion of the arm is connected to an end plate, and the second spring is set between the end plate and the fastening member.

11. The arm fixation module according to claim 9, further comprising:
an other arm, extending along a fifth direction, wherein an other first end portion of the other arm is pivotally connected to the housing, a fourth connecting portion is set at the other first end portion, and the fourth connecting portion protrudes from the other first end portion of the other arm along a sixth direction; and
an other locking assembly, set in the housing, wherein the other locking assembly comprises an other guide rail and an other fastening member, the other guide rail extends along a seventh direction toward the other first end portion of the other arm, the other fastening member slides in the other guide rail, a fifth connecting portion is set on a surface of the other fastening member facing the other arm, and the fifth connecting portion is recessed from the surface of the fastening member, wherein
when the sixth direction is parallel to the seventh direction, the fifth connecting portion is configured to connect to the fourth connecting portion, the other locking assembly further comprises a third spring, a side of the other guide rail away from the other first end portion of the other arm is connected to an end plate, and the third spring is set between the end plate and the other fastening member.

12. An unmanned aerial vehicle, comprising:
a plurality of arm fixation modules, wherein each of the arm fixation modules comprises:
a housing;
an arm, extending along a first direction, wherein the arm has a first end portion and a second end portion, the first end portion is pivotally connected to the housing, and a first connecting portion is set on the first end portion; and
a locking assembly, set in the housing, wherein the locking assembly comprises a fastening member, the fastening member is configured to move along a second direction, a second connecting portion is set on a surface of the fastening member facing the arm, the second connecting portion is configured to detachably connect to the first connecting portion, and the first direction is different from the second direction; and
a plurality of rotary wings, respectively pivotally connected to the second end portion of the arm of each of the arm fixation modules.

13. The unmanned aerial vehicle according to claim 12, wherein the housing of each of the arm fixation modules further comprises a strip-shaped through hole, the strip-shaped through hole extends along the second direction and comprises a first lock hole portion and a second lock hole portion, the fastening member further comprises a push lock, and the push lock comprises:
a connecting rod, movably connected to the fastening member, wherein the connecting rod extends through the strip-shaped through hole of the housing;
a protrusion, connected to a side surface of the connecting rod, wherein the protrusion is configured to engage the first lock hole portion or the second lock hole portion; and
a button, set outside the housing and connected to an end of the connecting rod.

14. The unmanned aerial vehicle according to claim 13, wherein the push lock of each of the arm fixation modules further comprises a plate and a first spring, the plate is sleeved on the connecting rod, the connecting rod extends through the first spring, the first spring is set between an inner side of the plate and the fastening member, and the protrusion is connected to the side surface of the connecting rod on an outer side of the plate.

15. The unmanned aerial vehicle according to claim 13, wherein the housing of each of the arm fixation modules further comprises a strip-shaped sliding groove set on an outer surface of the housing, the strip-shaped through hole is set in the strip-shaped sliding groove, and the button slides in the strip-shaped sliding groove.

16. The unmanned aerial vehicle according to claim 12, wherein
the first connecting portion protrudes from the first end portion along a third direction, and the second connecting portion is recessed from the surface of the fastening member; or
the first connecting portion is recessed from the first end portion along a third direction, and the second connecting portion protrudes from the surface of the fastening member.

17. The unmanned aerial vehicle according to claim 16, wherein a plurality of third connecting portions are respectively set at the first end portion of the arm of each of the arm fixation modules, each of the third connecting portions protrudes from the first end portion of the arm along a fourth direction, and when the third direction deviates from the second direction, the fastening member is configured to connect to the third connecting portion.

18. The unmanned aerial vehicle according to claim 12, wherein the arm of each of the arm fixation modules further comprises a supporting rod extending from the first end portion of the arm toward the bottom of the arm.

19. The unmanned aerial vehicle according to claim 12, wherein the locking assembly of each of the arm fixation modules further comprises a guide rail, the guide rail extends along the second direction toward the first end portion of the arm, and the fastening member is configured to slide along the guide rail.

20. The unmanned aerial vehicle according to claim 19, wherein the locking assembly of each of the arm fixation modules further comprises a second spring, a side of the guide rail away from the first end portion of the arm is connected to an end plate, and the second spring is set between the end plate and the fastening member.
